(19) United States
(12) Patent Application Publication
(10) Pub. No.: US 2019/0243439 A1
(43) Pub. Date: Aug. 8, 2019

(54) SYSTEM AND METHOD OF CONTROLLING POWER DOWN MODE OF MEMORY DEVICE

(71) Applicant: Samsung Electronics Co., Ltd., Suwon-si (KR)

(72) Inventor: Gyu-Hwan Cha, Suwon-si (KR)

(73) Assignee: Samsung Electronics Co., Ltd., Suwon-si (KR)

(21) Appl. No.: 16/194,512

(22) Filed: Nov. 19, 2018

(30) Foreign Application Priority Data
Feb. 5, 2018 (KR) 10-2018-0013857

(51) Int. Cl. G06F 1/3234; G06F 1/3296; G06F 1/324; G06F 1/3228

(52) U.S. Cl. CPC G06F 1/3275; G06F 1/3228; G06F 1/324; G06F 1/3296

(57) ABSTRACT

A system includes a memory controller configured to control an access to a memory device, a state monitor configured to monitor an operation state of the system to provide a monitoring signal indicating the operation state, a dynamic power controller configured to dynamically change a power control value based the monitoring signal, and control a mode conversion between an access mode in which the access to the memory device is performed and a power down mode in which the access to the memory device is not performed, based on the power control value, a plurality of master devices configured to generate requests for the access to the memory device, and an interconnect device coupled to the memory controller and the plurality of master devices through respective channels, the interconnect device being configured to perform an arbitrating operation on the requests.

### CROSS-REFERENCE TO RELATED APPLICATION

This U.S. Non-provisional application claims priority under 35 USC § 119 to Korean Patent Application No. 10-2018-0013857, filed on Feb. 5, 2018, in the Korean Intellectual Property Office (KIPO), the disclosure of which is incorporated by reference in its entirety herein.

### BACKGROUND

### 1. Technical Field

Example embodiments relate generally to semiconductor integrated circuits, and more particularly to a system and a method of dynamically controlling a power down mode of a memory device.

### 2. Discussion of the Related Art

A system-on-chip (SOC) indicates a chip or a system on the chip in which various semiconductor components are integrated as one chip. The recent market trend is away from application specific integrated circuits (ASICs) and application specific standard products (ASSPs), toward SOC technologies. Further, there is an increasing demand for reducing the size and increasing the performance level of the SOC. While the integration degree of the SOC may be increased by integrating additional components into one chip, an operational speed of the SOC may not increase sufficiently.

In conventional schemes, a power down mode of a memory device may be controlled using a fixed power control value. In this case, the power down mode must be controlled to be compatible with the maximum performance of the system, and the power consumption of the system is increased unnecessarily with the conventional schemes.

### SUMMARY

In order to address the aforementioned problems in the conventional art, some example embodiments provide a system and a method of dynamically changing a power control value according to an operation state of the system, and dynamically controlling a mode conversion between an access mode in which an access to a memory device is performed and a power down mode in which the access to the memory device is not performed, based on the variable power control value.

According to some example embodiments, a system includes a memory controller configured to control an access to a memory device, a state monitor configured to monitor an operation state of the system to provide a monitoring signal indicating the operation state, a dynamic power controller configured to change a power control value based the monitoring signal, and control a mode conversion between an access mode in which the access to the memory device is performed and a power down mode in which the access to the memory device is not performed, based on the power control value, a plurality of master devices configured to generate requests for the access to the memory device, and an interconnect device coupled to the memory controller and the plurality of master devices through respective channels, the interconnect device being configured to perform an arbitrating operation on the requests.

According to some example embodiments, a memory system includes a memory device, a memory controller configured to control an access to the memory device, and a dynamic power controller configured to change a power control value based a monitoring signal indicating an operation state of the memory system, and control a mode conversion between an access mode in which the access to the memory device is performed and a power down mode in which the access to the memory device is not performed, based on the power control value.

According to some example embodiments, a method of controlling a system includes providing a monitoring signal indicating an operation state of the system, changing a power control value based the monitoring signal, and controlling a mode conversion between an access mode in which the access to a memory device is performed and a power down mode in which the access to the memory device is not performed, based on the power control value.

In contrast to the conventional schemes, the system and the method according to some example embodiments may reduce power consumption of the system without degradation of performance of the system by dynamically controlling the mode conversion between the access mode and the power down mode.

### BRIEF DESCRIPTION OF THE DRAWINGS

Some example embodiments will be more clearly understood from the following detailed description taken in conjunction with the accompanying drawings.

FIG. 1 is a block diagram illustrating a system according to some example embodiments.

FIG. 2 is a flow chart illustrating a method of controlling a system according to some example embodiments.

FIG. 3 is a block diagram illustrating a dynamic power controller included in a system according to some example embodiments.

FIG. 4 is a timing diagram illustrating a mode conversion of a system according to some example embodiments.

FIG. 5 is a block diagram illustrating a memory device included in a system according to some example embodiments.

FIG. 6 is a block diagram illustrating an example of a power supply system of the memory device of FIG. 5 according to some example embodiments.

FIGS. 7 and 8 are diagrams for describing setting a power control value based on a type of a master device and an operation state according to some example embodiments.

FIG. 9 is a diagram for describing setting a power control value based on an entire bandwidth of an access to a memory device according to some example embodiments.

FIG. 10 is a diagram illustrating a buffer model for detecting a bandwidth according to some example embodiments.

FIG. 11 is a block diagram illustrating a state monitor using the buffer model of FIG. 10 according to some example embodiments.

FIG. 12 is a diagram illustrating an accumulator model for detecting a latency according to some example embodiments.

FIG. 13 is a block diagram illustrating a state monitor using the accumulator model of FIG. 12 according to some example embodiments.

FIG. 14 is a block diagram illustrating a latency detector included in the state monitor of FIG. 13 according to some example embodiments.

FIG. 15 is a timing diagram illustrating an example transaction performed by a system and an example current latency detected by the latency detector of FIG. 14 according to some example embodiments.

FIGS. 16A, 16B and 16C are diagrams illustrating a method of changing a power control value according to some example embodiments.

FIG. 17 is a block diagram illustrating a computing system including a system-on-chip (SOC) according to some example embodiments.

### DETAILED DESCRIPTION

Various example embodiments will be described more fully hereinafter with reference to the accompanying drawings, in which some example embodiments are shown. In the drawings, like numerals refer to like elements throughout. The repeated descriptions may be omitted. Some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, or in some cases be performed in reverse order.

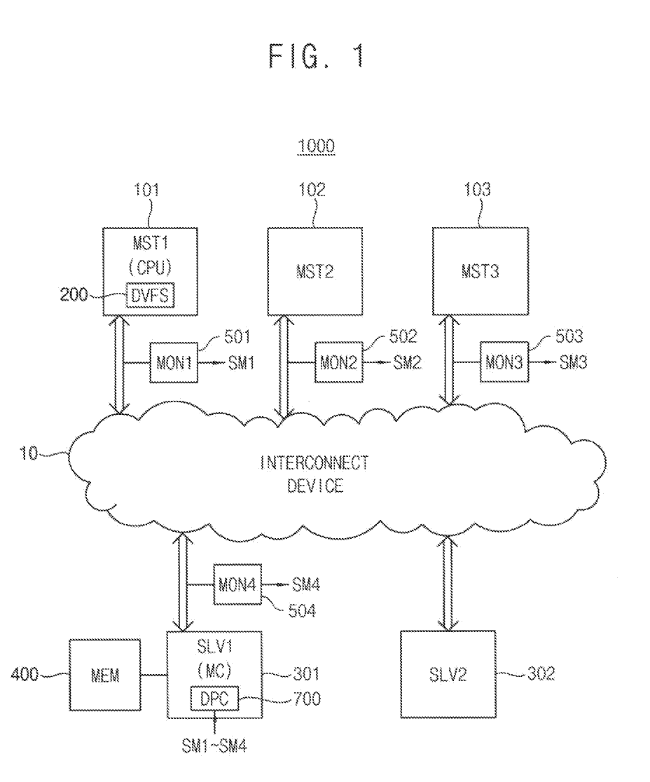

FIG. 1 is a block diagram illustrating a system according to some example embodiments. The system in this disclosure may be an application processor or a system-on-chip (SOC) in which various semiconductor components are integrated as one chip.

Referring to FIG. 1, a system 1000 may include master devices (MST1, MST2, MST3) 101, 102 and 103, slave devices (SLV1, SLV2) 301 and 302, a memory device (MEM) 400, state monitors (MON1, MON2, MON3, MON4) 501, 502, 503 and 504 and an interconnect device 10. In some exemplary embodiments, the system 1000 may be an SOC and the memory device 400 may be disposed external to the SOC.

The master devices 101, 102 and 103 may generate requests to demand services from at least one of the slave devices 301 and 302, respectively. At least one of the slave devices 301 and 302 may be shared by the master devices 101, 102 and 103 as a common resource.

For example, the first master device 101 may be a central processing unit (CPU) or a main processor. The first master device (CPU) 101 may manage power of the system 1000 using a dynamic voltage and frequency scaling (DVFS) module 200.

DVFS is a scheme of dynamically changing a voltage and/or a frequency according to an operation state of a system. In some example embodiments, the DVFS module 200 may be implemented in the form of software that is executed by the first master device (CPU) 101. In some other example embodiments, the DVFS module 200 may be implemented in the form of hardware or firmware.

The DVFS module 200 may determine an operation power level corresponding to a current operation state among a plurality of power levels. Each power level may be represented by at least one of an operation voltage and an operation frequency. In other words, the power level may be changed by changing at least one of the operation voltage and the operation frequency. The operation voltage may be a power supply voltage and the operation frequency may be a frequency of an operation clock signal, for example.

The DVFS module 200 may monitor workloads of the master devices 101, 102 and 103, the operation temperature of the system 1000, etc. to determine the operation power level corresponding to the current operation state. For example, when the workload of the first master device (CPU) 101 is increased, the DVFS module 200 may raise the operation power level so that the operation frequency and/or the operation frequency may be increased. In contrast, when the workload of the first master device (CPU) 101 is decreased, the DVFS module 200 may lower the operation power level so that the operation frequency and/or the operation frequency may be decreased. In some example embodiments, when the operation temperature of the system 1000 exceeds a threshold temperature range and the normal operation of the system 1000 is not secured, the DVFS module 200 may lower the operation power level.

The slave devices 301 and 302 and the master devices 101, 102 and 103 are coupled to the interconnect device 10 through respective channels. One or more channels may be implemented between the interconnect device 10 and each of the master and slave devices 101, 102, 103, 301 and 302. For example, the first slave device 301 may be a memory controller (MC), and a read channel and a write channel may be implemented between the interconnect device 10 and the first slave device (MC) 301. The interconnect device 10 may perform an arbitrating operation on the requests from the master devices 101, 102 and 103. The interconnect device 10 may include at least one arbiter for performing the arbitrating operation.

The state monitors 501, 502, 503 and 504 monitor the operation state of the system 1000 to provide monitoring signals SM1, SM2, SM3 and SM4. The state monitors 501, 502, 503 and 504 may monitor the operation state related with the corresponding master and slave devices, respectively. For example, as illustrated in FIG. 1, the first state monitor 501 may monitor the operation state of the first master device (CPU) 101, the second state monitor 502 may monitor the operation state of the second master device 102, the third state monitor 503 may monitor the operation state of the third master device 103, and the fourth state monitor 504 may monitor the operation state of the first slave device (MC) 301.

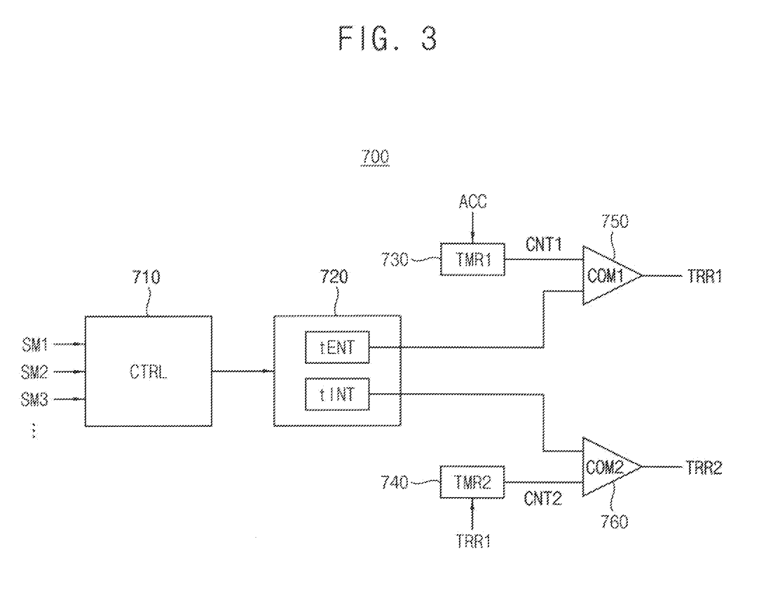

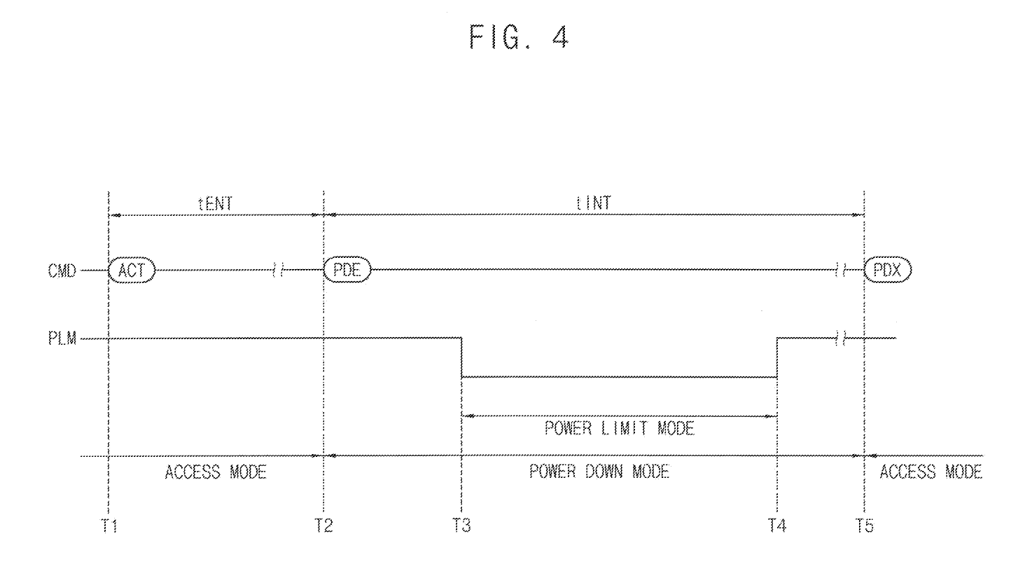

A dynamic power controller (DPC) 700 may dynamically change a power control value based the monitoring signals SM1, SM2, SM3 and SM4, and control a mode conversion between an access mode in which the access to the memory device 400 is performed and a power down mode in which the access to the memory device 400 is not performed, based on the power control value. As will be described below with reference to FIGS. 3 and 4, the power control value may include a first control value tENT indicating a first condition that the memory device 400 enters the power down mode from the access mode and a second control value tINT indicating a second condition that the memory device 400 maintains the power down mode.

FIG. 1 illustrates a non-limiting example embodiment that the dynamic power controller 700 is included in the first slave device (MC) 301. However, according to some other example embodiments, at least a portion of the dynamic power controller 700 may be disposed external to the first slave device (MC) 301.

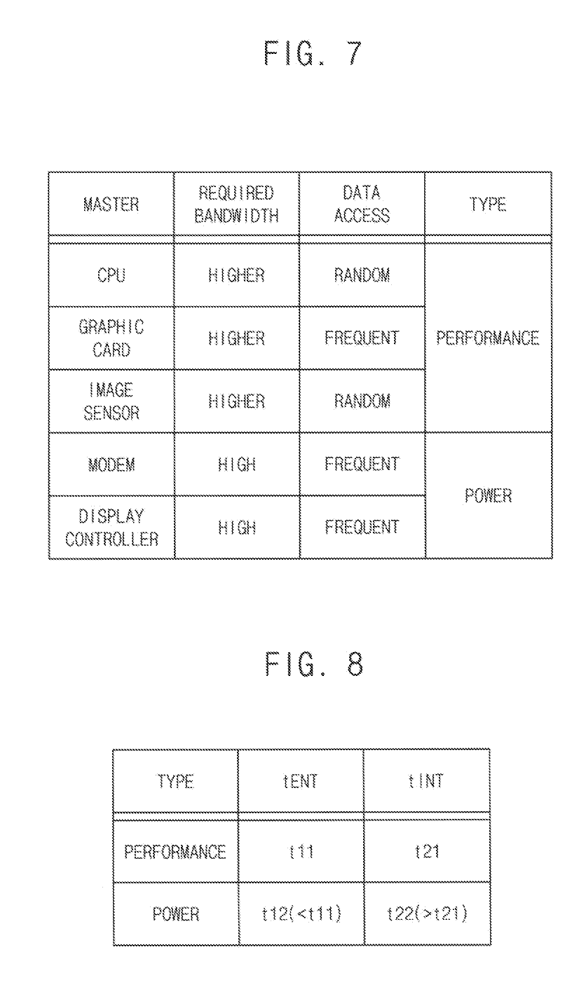

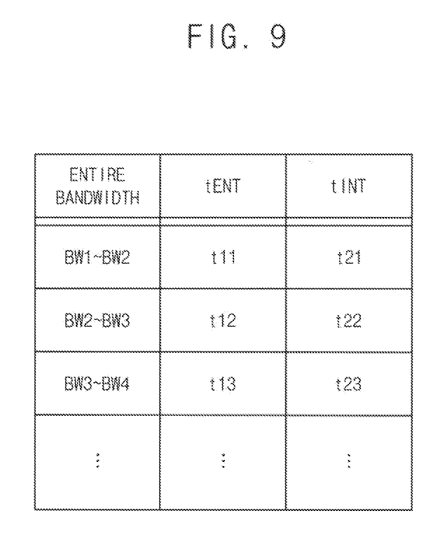

In some example embodiments, as will be described below with reference to FIGS. 7 and 8, the dynamic power controller 700 may change the power control value based on respective types of the master devices 101, 102 and 103 generating the requests for access to the memory device 400. In some other example embodiments, as will be described below with reference to FIG. 9, the dynamic power controller 700 may change the power control value based on an entire bandwidth of the access to the memory device 400 regardless of the respective types of the master devices 101, 102 and 103.

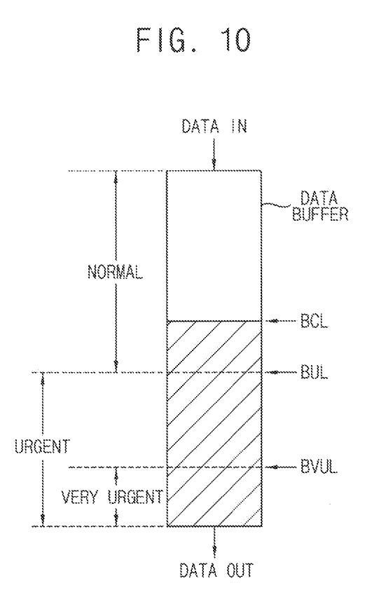

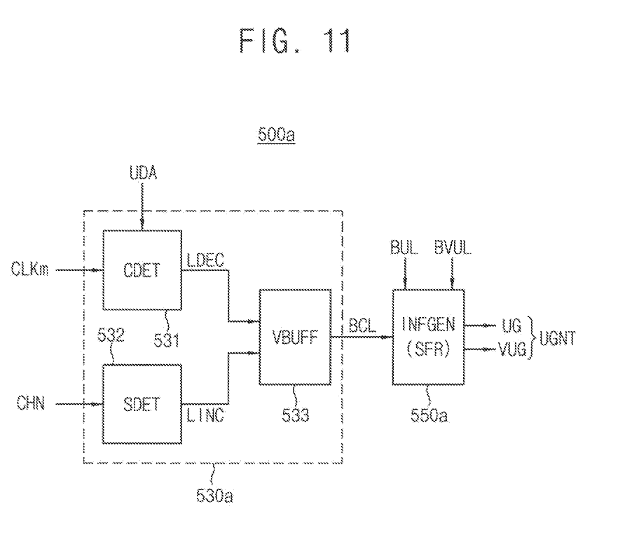

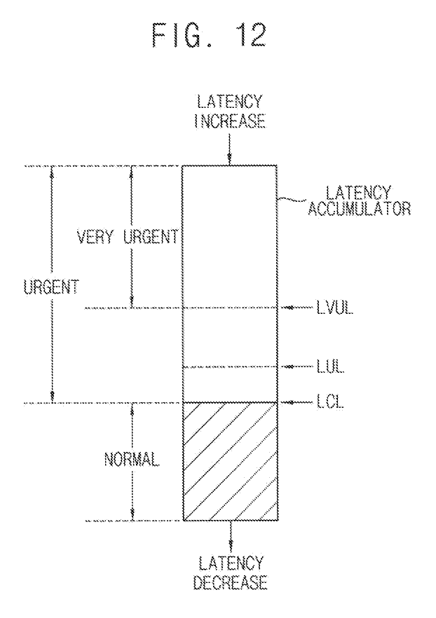

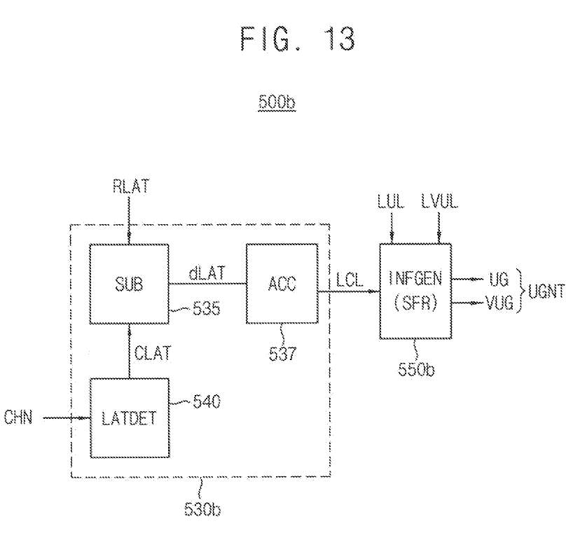

In some example embodiments, as will be described below with reference to FIGS. 10 and 11, the operation state may correspond to a data bandwidth. In some other example embodiments, as will be described below with reference to FIGS. 12 through 15, the operation state may correspond to a latency.

The numbers of the master devices and the slave devices in FIG. 1 is a non-limiting example and may be changed variously. The configurations of the state monitors may be the same or different from each other, depending on the operational characteristics of the corresponding master and slave devices, and some of the state monitors may be omitted according to some other example embodiments.

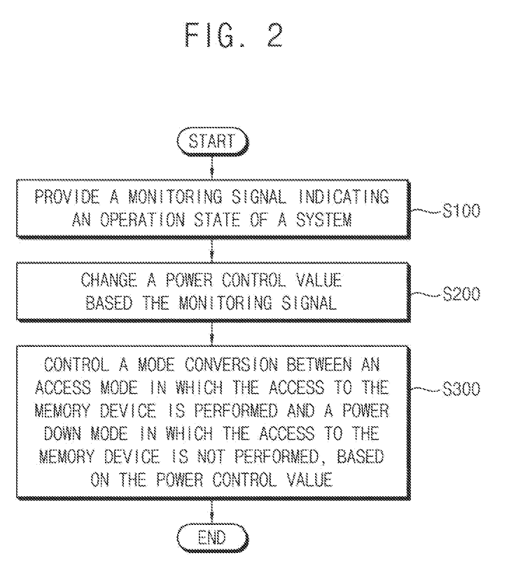

FIG. 2 is a flow chart illustrating a method of controlling a system according to some example embodiments.

Referring to FIGS. 1 and 2, the state monitors 501, 502, 503 and 504 may provide monitoring signals SM1, SM2, SM3 and SM4 indicating the operation state of the system 1000 (S100). The dynamic power controller 700 may change the power control value based the monitoring signals SM1, SM2, SM3 and SM4 (S200). The dynamic power controller 700 may control the mode conversion between the access mode in which the access to the memory device 400 is performed and the power down mode in which the access to the memory device 400 is not performed, based on the power control value (S300).

In this disclosure, the power down mode is differentiated from the access mode such that the access to the memory device is inhibited and the power consumption is decreased in the power down mode in comparison with the access mode. In conventional schemes, the power down mode of the memory device may be controlled using a fixed power control value. In this case, the power down mode is controlled to be compatible with the maximum performance of the system, and the power consumption of the system is increased unnecessarily with the conventional schemes.

In contrast to the conventional schemes, the system and the method according to some example embodiments may reduce power consumption without degradation of performance of the system by dynamically controlling the mode conversion between the access mode and the power down mode.

Hereinafter, some example embodiments are described with reference to FIGS. 3 through 17. Some elements irrelevant to descriptions of some example embodiments may be omitted in FIGS. 3 through 17, and repeated descriptions may also be omitted.

FIG. 3 is a block diagram illustrating a dynamic power controller included in a system according to some example embodiments.

Referring to FIG. 3, a dynamic power controller 700 may include a controller (CTRL) 710, a register 720, a first timer (TMR1) 730, a second timer (TMR2) 740, a first comparator (COM1) 750 and a second comparator (COM2) 760.

The controller 710 may determine a power control value based on one or more monitoring signals SM1, SM2 and SM3 indicating an operation state of a system. The register 720 may store the power control value provided from the controller 710. The power control value may include a first control value tENT indicating a first condition that the memory device enters the power down mode from the access mode and a second control value tINT indicating a second condition that the memory device maintains the power down mode.

The first timer 730 may be initiated in synchronization with an internal access signal ACC and performs a counting operation from an initiated time point to generate a first count value CNT1. The first comparator 750 may compare the first count value CNT1 and the first control value tENT to generate a first trigger signal TRR1 that is activated when the first count value CNT1 exceeds the first control value tENT. The internal access signal ACC may be a signal that is activated when the memory controller (MC) accesses the memory device. The memory controller may generate a power down entry command PDE in response to the activation of the first trigger signal TRR1.

The second timer 740 may be initiated in synchronization with the first trigger signal TRR1 and performs a counting operation from an initiated time point to generate a second count value CNT2. The second comparator 760 may compare the second count value CNT2 and the second control value tINT to generate a second trigger signal TRR2 that is activated when the second count value CNT2 exceeds the second control value tINT. The memory controller may generate a power down exit command PDX in response to the activation of the second trigger signal TRR2.

In some example embodiments, the dynamic power controller 700 of FIG. 3 may be implemented with a special function register (SFR) configured to perform a predetermined (and/or a desired) processing sequence based on stored values and input values. As will be described below with reference to FIG. 4, the first control value tENT corresponds to a first time interval (e.g., from T1 to T2 in FIG. 4) and the second control value tINT may correspond to a second time interval (e.g., from T2 to T5 in FIG. 4). For example, the first time interval tENT and the second time interval tINT may be represented by cycle numbers of a clock signal. The dynamic power controller 700 may control the memory device such that the memory device enters the power down mode from the access mode when an idle state of the memory device is maintained for the time interval tENT, where the idle state represents that the access to the memory device is not requested by the master devices. In addition, the dynamic power controller 700 may control the memory device such that the memory device wakes up from the power down mode to the access mode when the second time interval tINT elapses after the memory device enters the power down mode.

FIG. 4 is a timing diagram illustrating a mode conversion of a system according to some example embodiments. FIG. 4 shows a command signal CMD that is generated and provided from the first slave device (MC) 301 in FIG. 1, and a power limiting signal PLM that is generated in the memory device 400 in FIG. 1.

Referring to FIG. 4, the first slave device (MC) 301 may generate a power down command, including a power down entry command PDE and a power down exit command PDX, based on a frequency of generating an active command ACT.

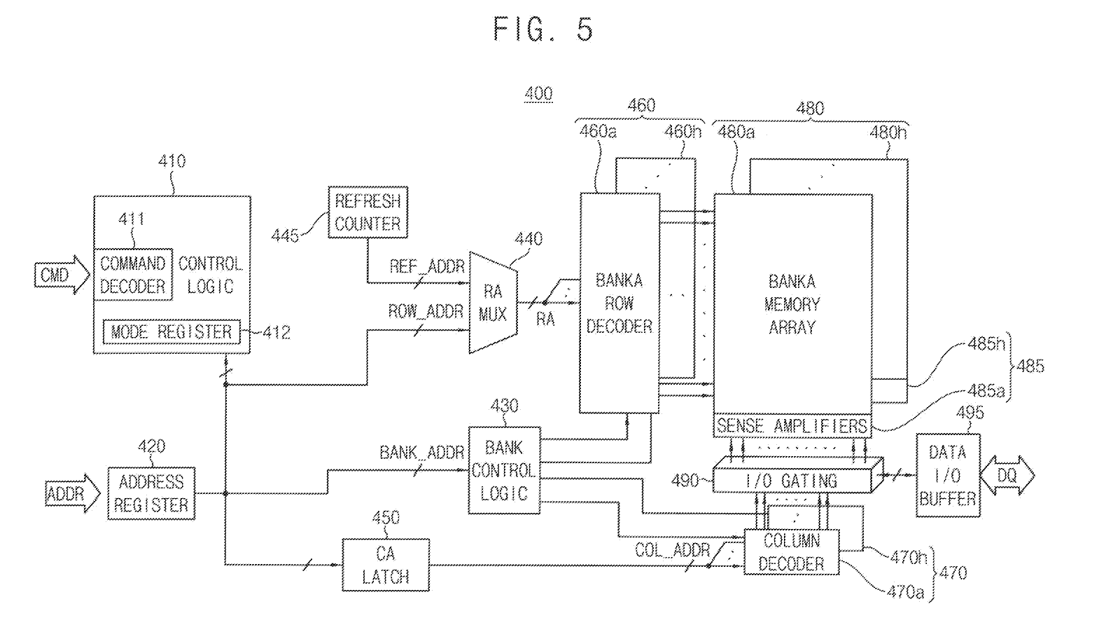

The first slave device (MC) 301 may generate the power down entry command PDE at time point T2 if the first slave device (MC) 301 does not generate an active command ACT for the first time interval tENT from time point T1 when the last active command ACT is issued. For example, the first slave device (MC) 301 may generate the power down entry command PDE when the idle state of the memory device 400 is maintained for the time interval tENT, where the idle state represents that the access to the memory device 400 is not performed with respect to all of memory cell array 480 (e.g., bank arrays 480a˜480h) in FIG. 5. In some example embodiments, as described with reference to FIG. 3, the first slave device (MC) 301 may generate the power down entry command PDE in response to the first trigger signal TRR1 that is generated from the dynamic power controller 700.

In addition, the first slave device (MC) 301 may generate the power down exit command PDX at time point T5 when the second time interval tINT elapses after the memory device 400 enters the power down mode at time point T2. In some example embodiments, as described with reference to FIG. 3, the first slave device (MC) 301 may generate the power down exit command PDX in response to the second trigger signal TRR2 that is generated from the dynamic power controller 700.

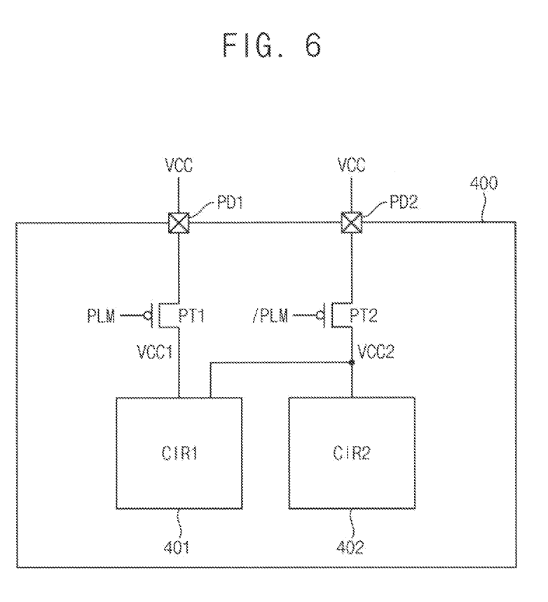

The first slave device (MC) 301 may generate internally a power limit signal PLM that is activated during the power down mode. As will be described below with reference to FIG. 6, the memory device 400 may block power to a portion of the memory device 400 based on the power limit signal PLM.

FIG. 4 illustrates a non-limiting example that the power limit signal PLM is activated in a logic low level. However, according to some other example embodiments, the power limit signal PLM may be activated in a logic high level.

As described with reference to FIGS. 3 and 4, the frequency of generating the power down entry command PDE to convert the memory device 400 from the access mode to the power down mode may be determined based on the first control value tENT. In addition, the duration of the power down mode, that is, timing of generating the power down exit command PDX to convert the memory device 400 from the power down mode to the access mode, may be determined based on the second control value tINT.

As such, the system and the method according to some example embodiments may dynamically change the power control values tENT and tINT based on the operation state of the system. Accordingly, power consumption of the system may be reduced without degradation of performance of the system by dynamically controlling the mode conversion between the access mode and the power down mode based on the variable power control value.

FIG. 5 is a block diagram illustrating a memory device included in a system according to some example embodiments.

A dynamic random access memory (DRAM) is described as a non-limiting example of a semiconductor memory device. However, according to some other example embodiments, the semiconductor memory device may be any of a variety of memory cell architectures, including, but not limited to, volatile memory architectures such as DRAM, thyristor RAM (TRAM) and static RAM (SRAM), or non-volatile memory architectures, such as read only memory (ROM), flash memory, phase change RAM (PRAM), ferroelectric RAM (FRAM), magnetic RAM (MRAM), and the like.

Referring to FIG. 5, a memory device 400 (e.g., a memory integrated circuit) includes a control logic 410, an address register 420, a bank control logic 430, a row address multiplexer (RA MUX) 440, a refresh counter 445, a column address (CA) latch 450, a row decoder 460, a column decoder 470, a memory cell array 480, a sense amplifier unit 485, an input/output (I/O) gating circuit 490 and a data input/output (I/O) buffer 495.

The memory cell array 480 may include a plurality of bank arrays 480a˜480h. The row decoder 460 may include a plurality of bank row decoders 460a˜460h respectively coupled to the plurality of bank arrays 480a˜480h, the column decoder 470 may include a plurality of bank column decoders 470a˜470h respectively coupled to the plurality of bank arrays 480a˜480h, and the sense amplifier unit 485 may include a plurality of bank sense amplifiers 485a˜485h respectively coupled to the plurality of bank arrays 480a˜480h.

The address register 420 may receive an address ADDR including a bank address BANK_ADDR, a row address ROW_ADDR and a column address COL_ADDR from the memory controller. The address register 420 may provide the received bank address BANK_ADDR to the bank control logic 430, may provide the received row address ROW_ADDR to the row address multiplexer 440, and may provide the received column address COL_ADDR to the column address latch 450.

The bank control logic 430 may generate bank control signals in response to the bank address BANK_ADDR. One of the bank row decoders 460a˜460hcorresponding to the bank address BANK_ADDR may be activated in response to the bank control signals, and one of the bank column decoders 470a˜470h corresponding to the bank address BANK_ADDR may be activated in response to the bank control signals.

The row address multiplexer 440 may receive the row address ROW_ADDR from the address register 420, and may receive a refresh row address REF_ADDR from the refresh counter 445. The row address multiplexer 440 may selectively output the row address ROW_ADDR or the refresh row address REF_ADDR as a row address RA. The row address RA that is output from the row address multiplexer 440 may be applied to activate one of the bank row decoders 460a˜460h.

The activated one of the bank row decoders 460a˜460h may decode the row address RA that is output from the row address multiplexer 440, and may activate a word-line corresponding to the row address RA. For example, the activated one of the bank row decoders 460a˜460h may apply a word-line driving voltage to the word-line corresponding to the row address RA.

The column address latch 450 may receive the column address COL_ADDR from the address register 420, and may temporarily store the received column address COL_ADDR. In some example embodiments, in a burst mode, the column address latch 450 may generate column addresses that increment from the received column address COL_ADDR. The column address latch 450 may apply the temporarily stored column address COL_ADDR (or in the burst mode, one of the generated column addresses) to activate one of the bank column decoders 470a˜470h.

The activated one of the bank column decoders 470a˜470h may decode the column address COL_ADDR (or in the burst mode, the one of the generated column addresses) that is output from the column address latch 450, and may control the I/O gating circuit 490 to output data corresponding to the column address COL_ADDR (or in the burst mode, the one of the generated column addresses).

The I/O gating circuit 490 may include circuitry for gating input/output data. The I/O gating circuit 490 may further include read data latches for storing data that is output from the bank arrays 480a˜480h, and write drivers for writing data to the bank arrays 480a˜480h.

Data to be read from one bank array of the bank arrays 480a˜480h may be sensed by a corresponding one of the bank sense amplifiers 485a˜485h coupled to the one bank array from which the data is to be read, and may be stored in the read data latches. The data stored in the read data latches may be provided to the memory controller via the data I/O buffer 495. Data DQ to be written in one bank array of the bank arrays 480a˜480h may be provided to the data I/O buffer 495 from the memory controller. The write driver may write the data DQ in the one bank array of the bank arrays 480a˜480h.

The control logic 410 may control operations of the memory device 400. For example, the control logic 410 may generate control signals for the memory device 400 to perform a write operation or a read operation. The control logic 410 may include a command decoder 411 that decodes a command CMD received from the memory controller and a mode register 412 that sets an operation mode of the memory device 400. For example, the command decoder 411 may generate the control signals corresponding to the command CMD by decoding a write enable signal, a row address strobe signal, a column address strobe signal, a chip selection signal, etc.

FIG. 6 is a block diagram illustrating an example of a power supply system of the memory device of FIG. 5 according to some example embodiments.

Referring to FIG. 6, a memory device 400 may include a first circuit (CIR1) 401 and a second circuit (CIR2) 402. The memory device 400, the mode conversion between the access mode and the power down mode of which is controlled by the dynamic power controller 700 as described above, may be a DRAM device of FIG. 5 according to some example embodiments. In the case of DRAM, the power down mode may correspond to a self-refresh mode in which the DRAM device performs a refresh operation internally regardless of a refresh command provided from the memory controller.

The first circuit 401 may be a circuit that is required for the self-refresh operation, and the second circuit 402 may be a circuit that is irrelevant to the self-refresh operation. As for the elements in FIG. 5, the first circuit 401 may include the row address multiplexer 440, the refresh counter 445, the row decoder 460, the memory cell array 480 and the sense amplifier unit 485, and the second circuit 402 may include the control logic 410, the address register 420, the bank control logic 430, the column address latch 450, the column decoder 470, the input/output (I/O) gating circuit 490 and the data input/output (I/O) buffer 495.

When the power limit signal PLM is activated, for example in a logic low level, a first power gating transistor PT1 is turned on and a second power gating transistor PT2 is turned off. Accordingly, a power supply voltage VCC1 through a first pad PD1 may be provided to only the first circuit 401 to perform the self-refresh operation and retain the data stored in the DRAM cells of the memory cell array 480.

In contrast, when the power limit signal PLM is deactivated (/PLM), for example in a logic high level, the first power gating transistor PT1 is turned off and the second power gating transistor PT2 is turned on. Accordingly, a power supply voltage VCC2 through a second pad PD2 may be provided to both of the first circuit 401 and the second circuit 402 to perform the normal access mode.

FIGS. 7 and 8 are diagrams for describing setting a power control value based on a type of a master device and an operation state according to some example embodiments.

The master devices generating the requests for the access to the memory device may include at least a first master device of a performance type requiring performance prior to power reduction and at least a second master device of a power type requiring power reduction prior to performance. That is, performance is considered a higher priority than power reduction for the first master device of the performance type, whereas power reduction is considered a higher priority than performance for the second master device of the power type. For example, as illustrated in FIG. 7, the first master device of the performance type may include a central processing unit (CPU), a graphic card, an image sensor, etc. and the second master device of the power type may include a modem, a display controller, etc. The required bandwidth may be varied according to the operation characteristics of the respective master devices. For example, some master devices may require relatively frequent data access, and some other master devices may require random data access.

The controller 710 in the dynamic power controller 700 of FIG. 3 may change the power control value based on a result of comparing an access requirement level of the first master device of the performance type with a reference level. The access requirement level may correspond to a bandwidth and/or a latency, as will be described below with reference to FIGS. 10 through 15.

Referring to FIG. 8, the controller 710 in the dynamic power controller 700 may determine the first control value or the first time interval tENT such that a value t11 of the performance type is larger than a value t12 of the power type. In other words, the first time interval tENT may be increased if the access requirement level is relatively urgent, so that the frequency of entering the power down mode may be reduced and the performance of the first master device of the performance type may be secured without degradation. Also, the controller 710 may determine the second control value or the second time interval tINT such that a value t21 of the performance type is smaller than a value t22 of the power type. In other words, the second time interval tINT may be decreased if the access requirement level is relatively urgent, so that the duration of staying in the power down mode may be reduced and the performance of the first master device of the performance type may be secured without degradation.

In contrast, in case of the second master device of the power type, the first time interval tENT may be reduced to increase the frequency of entering the power down mode, and the second time interval tINT may be increased to increase the duration of the power down mode, and thus the power consumption of the second master device of the power type may be reduced, as compared to the conventional schemes.

As such, the dynamic power controller 700 may change the power control value based on the respective types of the master devices generating the requests for access to the memory device 400, in contrast to the conventional schemes.

FIG. 9 is a diagram for describing setting a power control value based on an entire bandwidth of accesses to a memory device according to some example embodiments.

The controller 710 in the dynamic power controller 700 of FIG. 3 may change the power control value based on an entire bandwidth of the access to the memory device 400 regardless of the respective types of the master devices.

The controller 710 may divide the entire bandwidth into a plurality of bandwidth regions and assign different values to the plurality of bandwidth regions as illustrated in FIG. 9. In FIG. 9, a first entire bandwidth BW1 is smaller than a second entire bandwidth BW2, the second entire bandwidth BW2 is smaller than a third entire bandwidth BW3, the third entire bandwidth BW3 is smaller than a fourth entire bandwidth BW4, and so on. In this case, values t11, t12 and t13 of the first time interval tENT may be increased and values t21, t22 and t23 of the second time interval tINT may be decreased, as the entire bandwidth of the access to the memory device 400 is increased.

As such, the controller 710 in the dynamic power controller 700 may maintain and secure the performance of the system without degradation by increasing the first time interval tENT to decrease the frequency of entering the power down mode, and by decreasing the second time interval tINT to decrease the duration of the power down mode, as the entire bandwidth of the access to the memory device 400 is increased. In contrast, the controller 710 in the dynamic power controller 700 may reduce the power consumption of the system by decreasing the first time interval tENT to increase the frequency of entering the power down mode, and by increasing the second time interval tINT to increase the duration of the power down mode, as the entire bandwidth of the access to the memory device 400 is decreased. Thus, the power consumption of the system may be reduced while preventing (or limiting) degradation of the performance of the system, in contrast to the conventional schemes.

FIG. 10 is a diagram illustrating a buffer model for detecting a bandwidth according to some example embodiments.

Depending on the operational characteristic of the master device, a service requirement level or an access requirement level may be represented as a bandwidth. The bandwidth is a data amount that is served or transferred during a unit of time. For example, data may be served to the master device from the slave device (such as a memory controller) that is coupled to the master device through the interconnect device. The master device may store the served data in a data buffer to perform its own function on the stored data.

A data occupancy state of the data buffer in the master device is illustrated using oblique lines in FIG. 10, and the data occupancy state may be represented as a current bandwidth level BCL. The current bandwidth level BCL is increased when data are served (DATA IN) from the slave device (e.g., the memory controller), and the current bandwidth level BCL is decreased when the stored data are consumed (DATA OUT) by the master device.

According to an example overall operation scenario of the system, reference values such as a bandwidth urgent level BUL and a bandwidth very urgent level BVUL may be determined. An urgent information signal UGNT (discussed below with reference to FIG. 11) may be generated as the above-described monitoring signal based on the reference values BUL and BVUL and the current bandwidth level BCL. The master device may be considered as operating in a normal state when the current bandwidth level BCL is higher than the bandwidth urgent level BUL, in which case the urgent information signal UGNT may be deactivated.

The urgent information signal UGNT may include a plurality of bits or a plurality of signals to represent whether or how the current bandwidth level BCL corresponds to an urgent situation. For example, an urgent flag signal UG may be activated when the current bandwidth level BCL is lower than the bandwidth urgent level BUL, and a very urgent flag signal VUG may be activated when the current bandwidth level BCL is lower than the bandwidth very urgent level BVUL, as will be described below with reference to FIG. 11.

FIG. 11 is a block diagram illustrating a state monitor using the buffer model of FIG. 10 according to some example embodiments.

Referring to FIG. 11, a state monitor 500a may include a bandwidth monitor 530a and an information generator (INFGEN) 550a.

The bandwidth monitor 530a may generate a current bandwidth level BCL by detecting a bandwidth of a corresponding one of the master devices 101, 102 and 103 (e.g., in real-time). The bandwidth monitor 530a may include a consumed data detector (CDET) 531, a serviced data detector (SDET) 532 and a virtual buffer (VBUFF) 533.

For example, the consumed data detector 531 may generate a level decrease signal LDEC based on an operational clock signal CLKm of the corresponding one of the master devices 101, 102 and 103 and a unit amount UDA of consumed data. The serviced data detector 532 may generate a level increase signal LINC based on channel signals CHN transferred between the corresponding one of the master devices 101, 102 and 103 and the interconnect device 10. The virtual buffer 533 may generate the current bandwidth level BCL based on the level decrease signal LDEC and the level increase signal LINC.

The information generator 550a may generate the urgent information signal UGNT based on at least one of the reference values BUL and BVUL and the current bandwidth level BCL. For example, the reference values BUL and BVUL may be provided to and stored in the information generator 550a during an initializing stage of the system 1000. The information generator 550a may generate the urgent information signal UGNT based on the stored reference values BUL and BVUL.

For example, the information generator 550a may generate an urgent flag signal UG that is activated when the current bandwidth level BCL becomes lower than the bandwidth urgent level BUL, and may generate a very urgent flag signal VUG that is activated when the current bandwidth level BCL becomes lower than the bandwidth very urgent level BVUL. The information generator 550a may be implemented as a special function register (SFR) that performs predetermined (and/or desired) process sequences in response to stored values and input signals.

FIG. 12 is a diagram illustrating an accumulator model for detecting a latency according to some example embodiments.

Depending on the operational characteristic of the master device, a service requirement level or an access requirement level may be represented as a latency. The latency may be a delay from when the master device issues the request for service to when the requested service has completed. For example, the latency may be represented as a cycle number of a clock signal.

A latency state of an accumulator in the master device is illustrated using oblique lines in FIG. 12, and the latency state may be represented as a current latency level LCL. The current latency level LCL is increased when the latency of the accumulator is increased, and the current latency level LCL is decreased when the latency of the accumulator is decreased. A higher priority may be assigned as the current latency level LCL is increased, and a lower priority may be assigned as the current latency level LCL is decreased.

According to an example overall operation scenario of the system, reference values such as a latency urgent level LUL and a latency very urgent level LVUL may be determined. An urgent information signal UGNT (discussed below with reference to FIG. 13) may be generated as the above-described monitoring signal based on the reference values LUL and LVUL and the current latency level LCL. The master device may be considered as operating in a normal state when the current latency level LCL is lower than the latency urgent level LUL, in which case the urgent information signal UGNT may be deactivated.

The urgent information signal UGNT may include a plurality of bits or a plurality of signals to represent whether or how the current latency level LCL corresponds to an urgent situation. For example, an urgent flag signal UG may be activated when the current latency level LCL is higher than the latency urgent level LUL, and a very urgent flag signal VUG may be activated when the current latency level LCL is higher than the latency very urgent level LVUL, as will be described below with reference to FIG. 13.

FIG. 13 is a block diagram illustrating a state monitor using the accumulator model of FIG. 12 according to some example embodiments.

Referring to FIG. 13, a state monitor 500b may include a latency monitor 530b and an information generator (INFGEN) 550b.

The latency monitor 530b may generate a current latency level LCL by detecting a latency of a corresponding one of the master devices 101, 102 and 103 (e.g., in real-time). The latency monitor 530b may include a latency detector (LATDET) 540, a subtractor (SUB) 535 and an accumulator (ACC) 537.

The latency detector 540 may generate a current latency CLAT based on channel signals CHN transmitted between the corresponding one of the master devices 101, 102 and 103 and the interconnect device 10. The subtractor 535 may calculate a difference between a reference latency RLAT and the current latency CLAT to generate a latency difference value dLAT. The accumulator 537 may accumulate the latency difference value dLAT to generate the current latency level LCL.

The information generator 550b may generate the urgent information signal UGNT based on at least one of the reference values LUL and LVUL and the current latency level LCL. For example, the reference values LUL and LVUL may be provided to and stored in the information generator 550b during an initializing stage of the system 1000. The information generator 550b may generate the urgent information signal UGNT based on the stored reference values LUL and LVUL.

For example, the information generator 550b may generate an urgent flag signal UG that is activated when the current latency level LCL becomes higher than the latency urgent level LUL, and may generate a very urgent flag signal VUG that is activated when the current latency level LCL becomes higher than the latency very urgent level LVUL. The information generator 550b may be implemented as a special function register (SFR) that performs predetermined (and/or desired) process sequences in response to stored values and input signals.

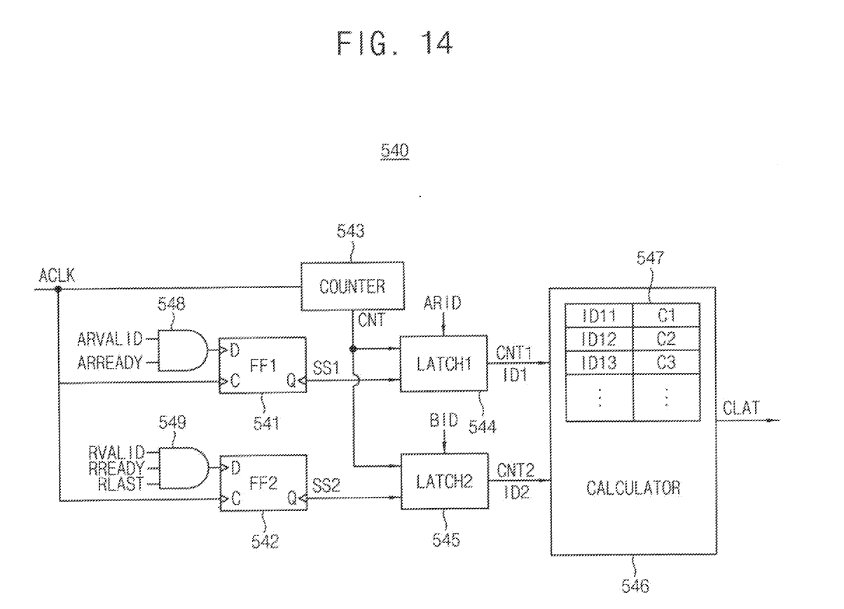

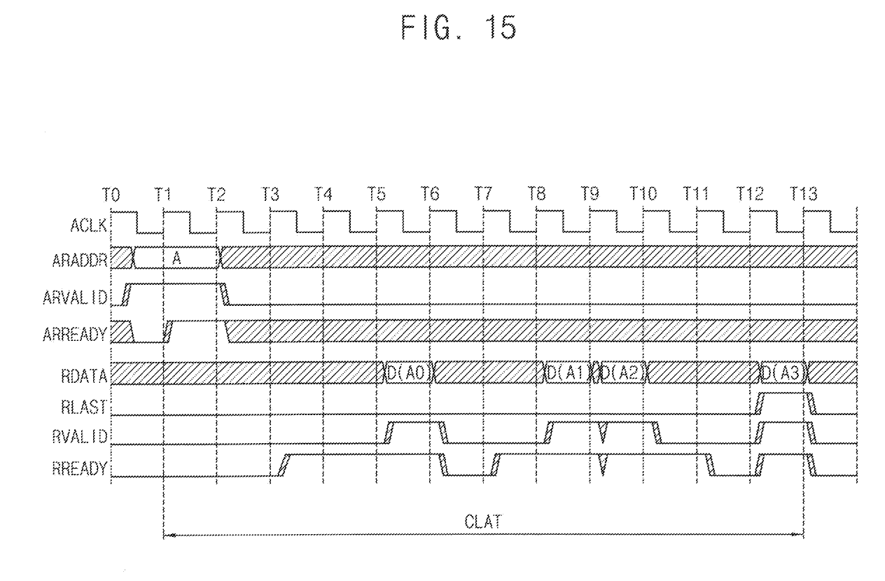

FIG. 14 is a block diagram illustrating a latency detector included in the state monitor of FIG. 13 according to some example embodiments.

Referring to FIG. 14, a latency detector 540 may include a first flip-flop (FF1) 541, a second flip-flop (FF2) 542, a counter 543, a first latch (LATCH1) 544, a second latch (LATCH2) 545, a calculator 546, a first logic gate 548 and a second logic gate 549.

For example, the first logic gate 548 may be implemented as an AND gate that performs an AND operation on a request valid signal ARVALID and a request ready signal ARREADY to output an operation result. The output of the first logic gate 548 is input to a data terminal D of the first flip-flop 541 and a global clock signal ACLK is input to a clock terminal C of the first flip-flop 541. The first flip-flop 541 samples the output of the first logic gate 548 in response to a rising edge of the global clock signal ACLK to output a first sampling signal SS1 though an output terminal Q of the first flip-flop 541.

For example, the second logic gate 549 may be implemented as an AND gate that performs an AND operation on a service valid signal RVALID, a service ready signal RREADY and a service done signal RLAST to output an operation result. The output of the second logic gate 549 is input to a data terminal D of the second flip-flop 542 and the global clock signal ACLK is input to a clock terminal C of the second flip-flop 542. The second flip-flop 542 samples the output of the second logic gate 549 in response to a rising edge of the global clock signal ACLK to output a second sampling signal SS2 though an output terminal Q of the second flip-flop 542.

The counter 543 counts a cycle number of the global clock signal ACLK to provide a count signal CNT.

The first latch 544 latches the count signal CNT in response to a rising edge of the first sampling signal SS1 to provide a start count signal CNT1. The first latch 544 may receive a first identification signal ARID associated with the request signals ARVALID and ARREADY to provide a first identification code ID1.

The second latch 545 latches the count signal CNT in response to a rising edge of the second sampling signal SS2 to provide an end count signal CNT2. The second latch 545 may receive a second identification signal BID associated with the service signals RVALID, RREADY and RLAST to provide a second identification code ID2.

The calculator 546 generates a current latency CLAT based on the start count signal CNT1 and the end count signal CNT2. When the system 1000 adopts a protocol supporting multiple outstanding transactions between the master devices, the interconnect device and the slave devices, the identification signals ARID and BID may be used to determine whether the request signals ARVALID and ARREADY are associated with the same transaction as the service signals RVALID, RREADY and RLAST.

When the start count signal CNT1 and the first identification code ID1 output from the first latch 544 are input to the calculator 546, the calculator 546 may update a mapping table 547 to store values ID11, ID12 and ID13 of the first identification code ID1 and corresponding count values C1, C2 and C3 of the start count signal CNT1. When the end count signal CNT2 and the second identification code ID2 output from the second latch 545 are input to the calculator 546, the calculator 546 extracts one of the count values C1, C2 and C3 from the mapping table 547 by comparing the value of the second identification signal ID2 and the previously stored values ID11, ID12 and ID13 of the first identification signal ID1.

The calculator 546 may generate the current latency CLAT by calculating the difference between the extracted value representing the service request timing point (the time at which the service request is issued) and the value representing the service done timing point (the time at which the requested service has completed).

FIG. 15 is a timing diagram illustrating an example transaction performed by a system and an example current latency detected by the latency detector of FIG. 14 according to some example embodiments.

FIG. 15 illustrates a non-limiting example of a read transaction according to an advanced extensible interface (AXI) protocol. The AXI protocol adopts a handshake scheme using valid signals and ready signals.

According to the handshake scheme, if a first one of a master interface and a slave interface transfers a signal to a second one of the master interface and the slave interface, the first one activates a valid signal, and then the second one activates a ready signal corresponding to the valid signal when the second one is ready to receive the signal. Sampling of signals is performed in response to rising edges of a global clock signal ACLK at both of the master interface and the slave interface. In other words, a valid signal transfer is fulfilled when both of the valid signal and the ready signal are activated at the same rising edge of the global clock signal ACLK.

As illustrated in FIG. 15, one of the master devices 101, 102 and 103 corresponding to the master interface activates a request valid signal ARVALID when the one of the master devices 101, 102 and 103 transfers a signal, and the interconnect device 10 corresponding to the slave interface activates a request ready signal ARREADY when the interconnect device 10 is ready to receive the signal from the one of the master devices 101, 102 and 103. In a similar manner, the interconnect device 10 activates a service valid signal RVALID when the interconnect device 10 transfers a signal, and the one of the master devices 101, 102 and 103 activates a service ready signal RREADY when the one of the master devices 101, 102 and 103 is ready to receive the signal from the interconnect device 10.

The rising edges of the global clock signal ACLK are represented as timing points T0 through T13 in FIG. 15. The one of the master devices 101, 102 and 103 corresponding to the master interface transfers a read request signal ARADDR to the interconnect device 10 corresponding to the slave interface by activating the request valid signal ARVALID corresponding to a service request signal. The read request signal ARADDR is transferred successfully at the timing point T2 when both of the request valid signal ARVALID and the request ready signal ARREADY are activated. The one of the master devices 101, 102 and 103 may determine the timing point T1 as a service request timing point (the time at which the service request is issued) based on the request valid signal ARVALID regardless of the request ready signal ARREADY, that is, regardless of the success of the transfer of the read request signal ARADDR to the interconnect device 10.

As a response to the read request signal ARADDR, data D(A0), D(A1), D(A2) and D(A3) of a burst type are transferred from the interconnect device 10 to the one of the master devices 101, 102 and 103. The data D(A0), D(A1), D(A2) and D(A3) are transferred successfully at timing points T6, T9, T10 and T13, respectively, when both of the service valid signal RVALID and the service ready signal RREADY are activated. The interconnect device 10 activates a service done signal RLAST with transferring the last data D(A3), and the timing point T13 is determined as a service done timing point (the time at which the requested service has completed).

As such, the latency detector 540 of FIG. 14 may detect the current latency CLAT based on the request signals ARVALID and ARREADY and the service signals RVALID, RREADY and RLAST among the channel signals CHN between the one of the master devices 101, 102 and 103 and the interconnect device 10.

The state monitors 501, 502 and 503 in FIG. 1 may generate the monitoring signals SM1, SM2 and SM3 indicating the operation state of the system 1000 by monitoring the access requirement levels of the corresponding master devices 101, 102 and 103, respectively. The first, second and third state monitors 501, 502 and 503 may monitor the bandwidth and/or the latency of the first, second and third master devices 101, 102 and 103, respectively, as described above. The fourth state monitor 504 may monitor the entire bandwidth of the access to the memory device 400 to generate the monitoring signal SM4 indicating the operation state of the system 1000.

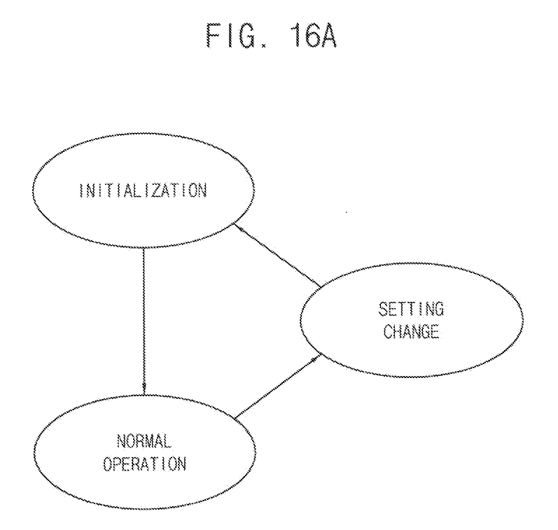

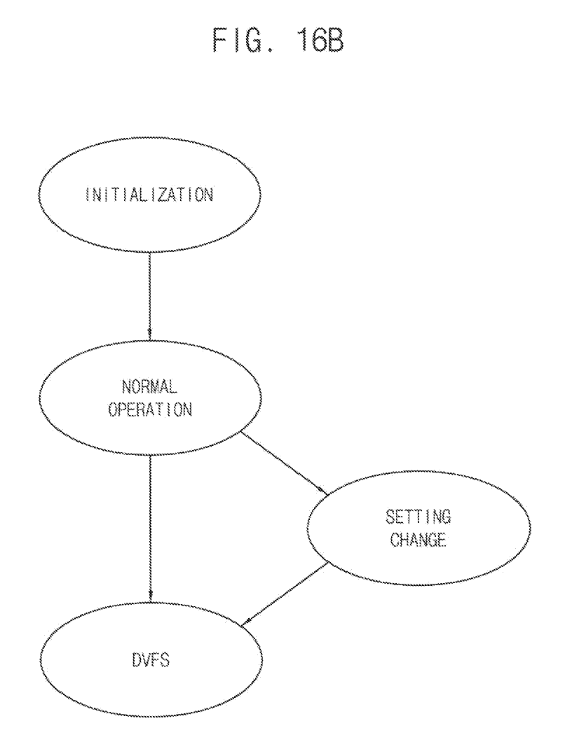

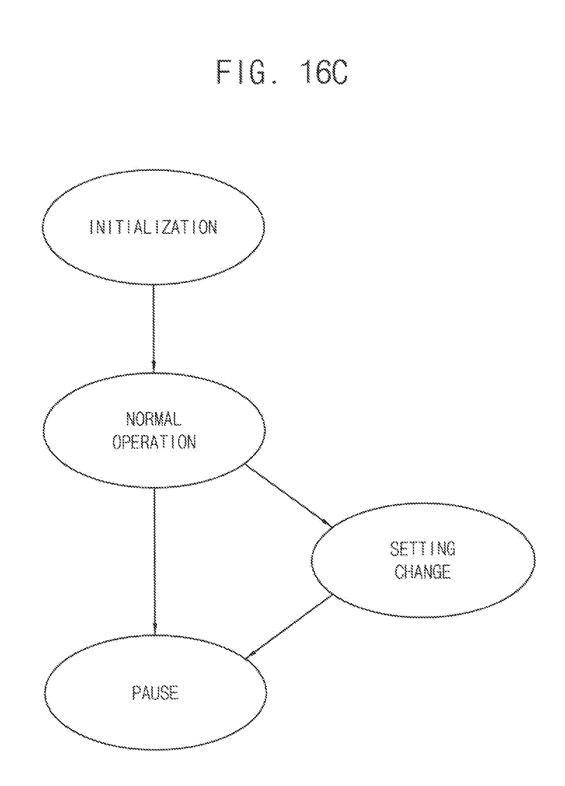

FIGS. 16A, 16B and 16C are diagrams illustrating a method of changing a power control value according to some example embodiments.

The change of the power control value may be performed dynamically by storing the changed control values tENT and tINT in the register 720 of the dynamic power controller 700 of FIG. 3. The change of the power control value may cause operation errors of the system if performed while the access to the memory device 400 is performed, and thus the power control value has to be changed while the access to the memory device 400 is not performed to avoid such operation errors.

Referring to FIG. 16A, in general, a system may perform an initialization operation, and then perform a normal operation after the initialization operation is completed. The operation state of the system may be monitored during the normal operation. When a change of the power control value is required according to the monitoring result, the system may perform the initialization operation again, and the dynamic power controller 700 may change the power control value during the initialization operation.

Referring to FIG. 16B, when a change of the power control value is required, the system may perform the DVFS operation as described with reference to FIG. 1, and the dynamic power controller 700 may change the power control value during the DVFS operation. In general, the access to the memory device 400 is inhibited during the DVFS operation, and thus the operation errors of the system may be prevented by changing the power control value during the DVFS operation.

Referring to FIG. 16C, when a change of the power control value is required, the system may perform a pause mode in which the access to the memory device 400 is inhibited, and the dynamic power controller may change the power control value during the pause mode. Thus, the operation errors of the system may be prevented by changing the power control value during the pause mode. In comparison with the example embodiment of FIG. 16B, the control of the voltage and/or frequency is unnecessary and only the change of the power control value may be performed during the pause mode with the example embodiment of FIG. 16C.

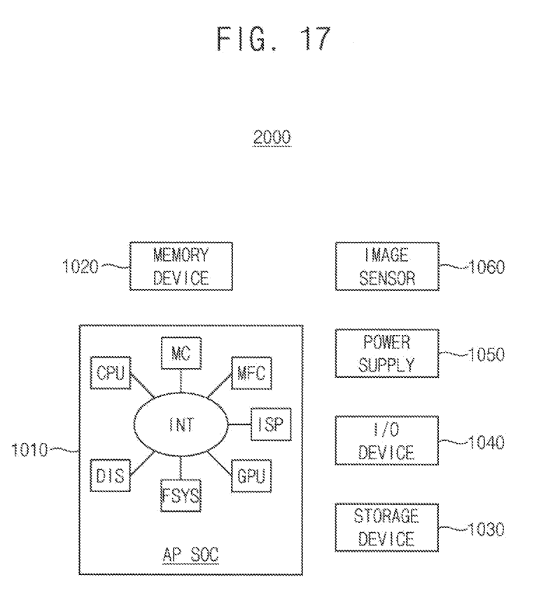

FIG. 17 is a block diagram illustrating a computing system including a system-on-chip (SOC) according to some example embodiments.

Referring to FIG. 17, a computing system 2000 may include a system-on-chip (SOC) 1010, a memory device 1020, a storage device 1030, an input/output (I/O) device 1040, a power supply 1050 and an image sensor 1060. Although not illustrated in FIG. 17, the computing system 2000 may further include ports that communicate with a video card, a sound card, a memory card, a USB device, and/or various other electronic devices.

The SOC 1010 may be an application processor (AP) SOC including an interconnect device INT and a plurality of intellectual properties coupled to the interconnect device INT as described with reference to FIGS. 1 through 16C. As illustrated in FIG. 17, the intellectual properties may include a memory controller MC, a central processing unit CPU, a display controller DIS, a file system block FSYS, a graphic processing unit GPU, an image signal processor ISP, a multi-format codec block MFC, etc. According to some example embodiments, the memory controller MC may include the dynamic power controller 700 as described above. The dynamic power controller 700 may dynamically change the power control value based on the monitoring signal, and control the mode conversion between the access mode and the power down mode to reduce power consumption of the computing system 2000 without degradation of performance of the computing system 2000.

The SOC 1010 may communicate with the memory device 1020, the storage device 1030, the input/output device 1040 and/or the image sensor 1060 via a bus, such as an address bus, a control bus, and/or a data bus. In some example embodiments, the SOC 1010 may be coupled to an extended bus, such as a peripheral component interconnection (PCI) bus.

The memory device 1020 may store data for operating the computing system 2000. For example, the memory device 1020 may be implemented with a dynamic random access memory (DRAM) device, a mobile DRAM device, a static random access memory (SRAM) device, a phase random access memory (PRAM) device, a ferroelectric random access memory (FRAM) device, a resistive random access memory (RRAM) device, and/or a magnetic random access memory (MRAM) device. The storage device 1030 may include a solid state drive (SSD), a hard disk drive (HDD), a CD-ROM, etc. The input/output device 1040 may include an input device (e.g., a keyboard, a keypad, a mouse, etc.) and an output device (e.g., a printer, a display device, etc.). The power supply 1050 supplies operation voltages for the computing system 2000.

The image sensor 1060 may communicate with the SOC 1010 via the buses and/or other communication links. As described above, the image sensor 1060 may be integrated with the SOC 1010 in one chip according to some example embodiments, or the image sensor 1060 and the SOC 1010 may be implemented as separate chips according to some other example embodiments.

As described above, in contrast to the conventional schemes, the system and the method according to some example embodiments of the inventive concepts may reduce power consumption of the system without degradation of performance of the system by dynamically controlling the mode conversion between the access mode (in which an access to a memory device is performed) and the power down mode (in which the access to the memory device is not performed), based on a variable power control value.

As will be appreciated by one skilled in the art, some example embodiments of the inventive concepts may be embodied as a system, a method, or a computer program product embodied in one or more computer readable medium(s) having computer readable program code embodied thereon. The computer readable program code may be provided to one or more processor(s) of a general purpose computer, special purpose computer, or other programmable data processing apparatus. The computer readable medium may be a computer readable signal medium or a non-transitory computer readable storage medium. The non-transitory computer readable storage medium may be any tangible medium that can contain, or store a program for use by or in connection with an instruction execution system, apparatus, or device.

Units and/or devices according to some example embodiments may be implemented using hardware, a combination of hardware and software, or storage media storing software. Hardware may be implemented using processing circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUs), one or more microprocessors, one or more Application Specific Integrated Circuits (ASICs), or any other device or devices capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, etc., capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., one or more processors, CPUs, controllers, ALUs, DSPs, microcomputers, microprocessors, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor. In another example, the hardware device may be an integrated circuit customized into special purpose processing circuitry (e.g., an ASIC).

A hardware device, such as a computer processing device, may run an operating system (OS) and one or more software applications that run on the OS. The computer processing device also may access, store, manipulate, process, and create data in response to execution of the software. For simplicity, some example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Software and/or data may be embodied permanently or temporarily in any type of storage media including, but not limited to, any machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including tangible or non-transitory computer-readable storage media as discussed herein.

Storage media may also include one or more storage devices at units and/or devices according to one or more example embodiments. The one or more storage devices may be tangible or non-transitory computer-readable storage media, such as random access memory (RAM), read only memory (ROM), a permanent mass storage device (such as a disk drive), and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the storage media, the computer programs, program code, instructions, or some combination thereof, may be specially designed and constructed for the purposes of the example embodiments, or they may be known devices that are altered and/or modified for the purposes of example embodiments.

The inventive concepts may be applied to any electronic devices and systems requiring a personal information management (PIM) tool for securely managing sensitive personal data and/or encrypted data. For example, the inventive concepts may be applied to electronic devices and systems such as a memory card, a solid state drive (SSD), an embedded multimedia card (eMMC), a mobile phone, a smart phone, a personal digital assistant (PDA), a portable multimedia player (PMP), a digital camera, a camcorder, personal computer (PC), a server computer, a workstation, a laptop computer, a digital TV, a set-top box, a portable game console, a navigation system, a wearable device, an internet of things (IoT) device, an internet of everything (IoE) device, an e-book, a virtual reality (VR) device, an augmented reality (AR) device, etc.

The foregoing is illustrative of some example embodiments of the inventive concepts and is not to be construed as limiting thereof. Although some example embodiments have been described, those skilled in the art will readily appreciate that many modifications are possible in these example embodiments without materially departing from the spirit and scope of the inventive concepts as set forth in the following claims.

What is claimed is:

1. A system comprising:
a memory controller configured to control an access to a memory device;
a state monitor configured to monitor an operation state of the system to provide a monitoring signal indicating the operation state;
a dynamic power controller configured to change a power control value based the monitoring signal, and control a mode conversion between an access mode in which the access to the memory device is performed and a power down mode in which the access to the memory device is not performed, based on the power control value;
a plurality of master devices configured to generate requests for the access to the memory device; and
an interconnect device coupled to the memory controller and the plurality of master devices through respective channels, the interconnect device being configured to perform an arbitrating operation on the requests.

2. The system of claim 1, wherein the power control value includes a first control value indicating a first condition that the memory device enters the power down mode from the access mode and a second control value indicating a second condition that the memory device maintains the power down mode.

3. The system of claim 2, wherein the first control value corresponds to a first time interval, and the dynamic power controller is configured to control the memory device such that the memory device enters the power down mode from the access mode when an idle state of the memory device is maintained for the first time interval, the idle state representing that the access to the memory device is not requested by the plurality of master devices.

4. The system of claim 2, wherein the second control value corresponds to a second time interval, and the dynamic power controller is configured to control the memory device such that the memory device wakes up from the power down mode to the access mode when the second time interval elapses after the memory device enters the power down mode.

5. The system of claim 1, wherein the dynamic power controller is configured to change the power control value based on respective types of the plurality of master devices generating the requests for the access to the memory device.

6. The system of claim 5, wherein the plurality of master devices includes at least a first master device of a performance type for which performance is a higher priority than power reduction and at least a second master device of a power type for which power reduction is a higher priority than performance.

7. The system of claim 6, wherein the dynamic power controller is configured to change the power control value based on a result of comparing an access requirement level of the first master device of the performance type with a reference level.

8. The system of claim 1, wherein the dynamic power controller is configured to change the power control value based on an entire bandwidth of the access to the memory device regardless of respective types of the plurality of master devices.

9. The system of claim 8, wherein the dynamic power controller is configured to divide the entire bandwidth into a plurality of bandwidth regions and assign different values to the plurality of bandwidth regions.

10. The system of claim 1, wherein the state monitor includes:
a bandwidth monitor configured to provide a current bandwidth level by detecting a bandwidth of the access to the memory device by a corresponding master device among the plurality of master devices in real-time; and
an information generator configured to generate the monitoring signal based on the current bandwidth level.

11. The system of claim 1, wherein the state monitor includes:
a latency monitor configured to provide a current latency level by detecting a latency of a corresponding master device among the plurality of master devices in real-time; and
an information generator configured to generate the monitoring signal based on the current latency level.

12. The system of claim 1, wherein the state monitor includes:
a bandwidth monitor configured to provide a current bandwidth level by detecting an entire bandwidth of the access to the memory device by the plurality of master devices in real-time; and
an information generator configured to generate the monitoring signal based on the current bandwidth level.

13. The system of claim 1, wherein, when a change of the power control value is required, the system is configured to perform an initialization operation, and the dynamic power controller is configured to change the power control value during the initialization operation.

14. The system of claim 1, wherein, when a change of the power control value is required, the system is configured to perform a dynamic power and frequency scaling (DVFS) operation, and the dynamic power controller is configured to change the power control value during the DVFS operation.

15. The system of claim 1, wherein, when a change of the power control value is required, the system is configured to perform a pause mode in which the access to the memory device is inhibited, and the dynamic power controller is configured to change the power control value during the pause mode.

16. The system of claim 1, wherein the memory device is a dynamic random access memory (DRAM) device.

17. The system of claim 16, wherein the power down mode includes a self-refresh mode in which the DRAM device is configured to perform a refresh operation internally regardless of a refresh command provided from the memory controller.

18. A memory system comprising:
a memory device;
a memory controller configured to control an access to the memory device; and
a dynamic power controller configured to change a power control value based a monitoring signal indicating an operation state of the memory system, and control a mode conversion between an access mode in which the access to the memory device is performed and a power down mode in which the access to the memory device is not performed, based on the power control value.

19. A method of controlling a system, comprising:
providing a monitoring signal indicating an operation state of the system;
changing a power control value based the monitoring signal; and
controlling a mode conversion between an access mode in which an access to a memory device is performed and a power down mode in which the access to the memory device is not performed, based on the power control value.

20. The method of claim 19, wherein the power control value includes a first control value indicating a first condition that the memory device enters the power down mode from the access mode and a second control value indicating a second condition that the memory device maintains the power down mode.
